(19) United States
(12) Patent Application Publication
(10) Pub. No.: US 2015/0008693 A1
(43) Pub. Date: Jan. 8, 2015

(54) Collapsible Sidewall Extender for Vehicles

(71) Applicant: Panayiotis Andreou, Surrey (CA)

(72) Inventor: Panayiotis Andreou, Surrey (CA)

(21) Appl. No.: 13/934,716

(22) Filed: Jul. 3, 2013

(51) Int. Cl. B62D 33/03

(52) U.S. Cl. CPC B62D 33/03
USPC 296/26.06

(57) ABSTRACT

A collapsible sidewall height extender for use with a vehicle having an open storage bed with opposed sidewalls which includes a first horizontal side member and a second horizontal side member. Each of the first horizontal side member and the second horizontal side member have at least one support member with a first end and a second end.

The first end of the at least one support member is pivotally secured to the first horizontal side member and the second end of the at least one support member is adapted to be pivotally secured to a respective side wall of a storage bed of a vehicle, such that the first horizontal side member and the second horizontal side member are movable between an operational position and a storage position.

### FIELD

The present invention relates to collapsible sidewall extenders for vehicles.

### BACKGROUND

Presently there are a number of options available for extending the length of a pickup truck bed to increase the carrying capacity. Many of these options involve lowering the tailgate and attaching a form of frame to the tailgate or sidewalls of the truck bed. Such frames can be permanently installed or removable as desired. Examples of such adaptations can be found in U.S. Pat. No. 7,681,935 and U.S. Pat. No. 7,959,203. These solutions are suitable when the cargo is of a length that cannot be accommodated by the original length of the truck bed. It is not a suitable solution when the cargo is of a height or volume that requires higher side walls on a truck bed.

Standard truck beds are approximately 6 feet to 8 feet in length and have a width between the opposed sidewalls that is approximately 5 to 6 feet. Standard truck boxes usually have around 20 and 25 inches vertical depth from the top of opposed sidewalls to the bottom of the bed. Some types of cargo are too tall to be safely supported by the 20 to 25 inch side walls. Other types of cargo such as those comprised of loose materials can only be loaded to the height of the bed otherwise they will over flow the truck bed. This limits the amount of cargo that can be transported at a given time.

Where users need to transport materials that are substantially taller than the sidewalls, or are required to be stacked, or are of volume that exceeds the height of the sidewalls, the options are limited. Rudimentary frames can be installed to raise the height of the sidewalls. Alternatively, panels can also be installed. These options while reasonably effective tend to be permanent and can be unsightly when not in use. Moreover, permanently installed sidewall extensions tend to limit the use of the truck bed for other functions.

What is required is a sidewall extender for a truck bed that can be easily installed to raise the height of the sidewalls as necessary, and which can be lowered or removed from sight when not in use.

### SUMMARY

There is provided a collapsible sidewall height extender for use with a vehicle having an open storage bed with opposed sidewalls. The collapsible sidewall height extender includes a first horizontal side member and a second horizontal side member. Each of the first horizontal side member and the second horizontal side member a plurality of supports spaced at intervals. Each support member has a first end and a second end. first end of each support member is pivotally secured to the first horizontal side member and the second end of the at least one support member is adapted to be pivotally attached to an inner side of the respective side wall of a storage bed of a vehicle, such that the first horizontal side member and the second horizontal side member are movable between an operational position and a storage position. The supports are substantially vertical in the operational position, with the first horizontal side member being horizontal and spaced from the top edge of the sidewall of the truck.

There is further provided a collapsible leg bracket that is positioned toward the first end of two of the support members, and extends diagonally to the first horizontal side member to maintain and lock the first horizontal support member in the operational position. When the collapsible leg bracket is disengaged, the first horizontal side member can be pivotally moved to the storage position.

Also provided is a removable elongate storage cap to cover the collapsible sidewall height extender when in the storage position. The removable elongate storage cap can be laid over each of the first horizontal side member and the second horizontal side member. It can be resting on or permanent attached to the top edge of the sidewall to the truck bed. The storage cap has a lid on a living hinge which can be opened to allow for access to the first horizontal side member and the second horizontal side member.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a pickup truck.

FIG. 2 is a first side elevation view of the collapsible sidewall extender of the present invention.

FIG. 3 a section view of the bed of a pickup truck with the collapsible sidewall extender.

FIG. 4 is a side elevation view in section of the bed of standard tuck bed with the collapsible sidewall extender in a first position.

FIG. 5 is a side elevation view in section of the bed of standard tuck bed with the collapsible sidewall extender in a second position.

FIG. 6 is a side elevation view of the exterior of standard tuck bed with collapsible sidewall extender in a first position with tall cargo.

FIG. 7 is a side elevation view of an alternative embodiment of the side rack.

FIG. 8 is a side elevation view of the collapsible sidewall extender stored within a covered with a storage cap.

FIG. 9 is an end elevation view of storage cap for collapsible sidewall extender with the cap closed.

FIG. 10 is an end elevation view of storage cap for collapsible sidewall extender with the cap open.

FIG. 11 is side elevation view of the collapsible sidewall extender showing telescopic support members.

FIG. 12 is a top plan view of the bed pickup truck with the collapsible sidewall extender featuring traverse supports.

### DETAILED DESCRIPTION

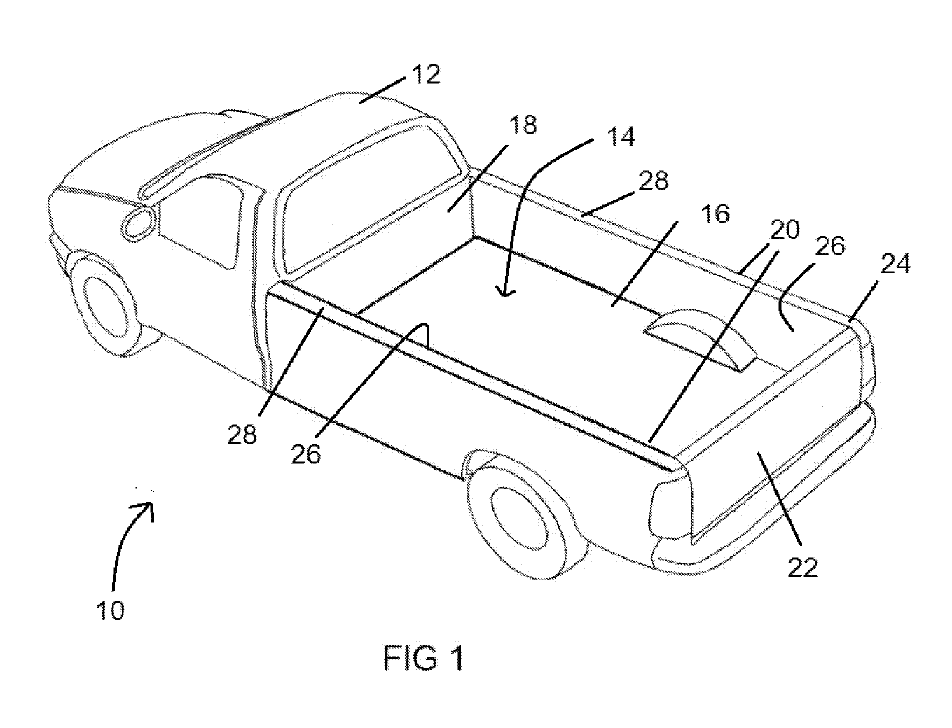

A collapsible sidewall extender for a vehicle will now be described with reference to FIG. 1 through FIG. 12.

### Structure and Relationship of Parts:

Referring to FIG. 1 there is illustrated a standard truck generally referenced by numeral 10. The truck 10 has a cab 12, with an open bed 14. The bed 14 has a bottom 16, and a first end 18 adjacent to the cab 12. There are also two opposed sidewalls 20, and a closable tail gate 22 provided at a second end 24. The illustrated truck bed 14 has a standard measurement of 6 feet to 6.5 feet in length from the first end 18 to the tail gate 22. The width between the opposed sidewalls 20 is between 5 to 6 feet. Standard truck boxes 14 usually have a 20 to 25 inch vertical depth below a top 24 of the sidewalls 20. It will be appreciated that there different truck models result in variations in the dimensions of truck beds 14 such that they may be longer or shorter than illustrated and the sidewalls 20 may be that may be shallower or deeper than the vertical depths illustrated.

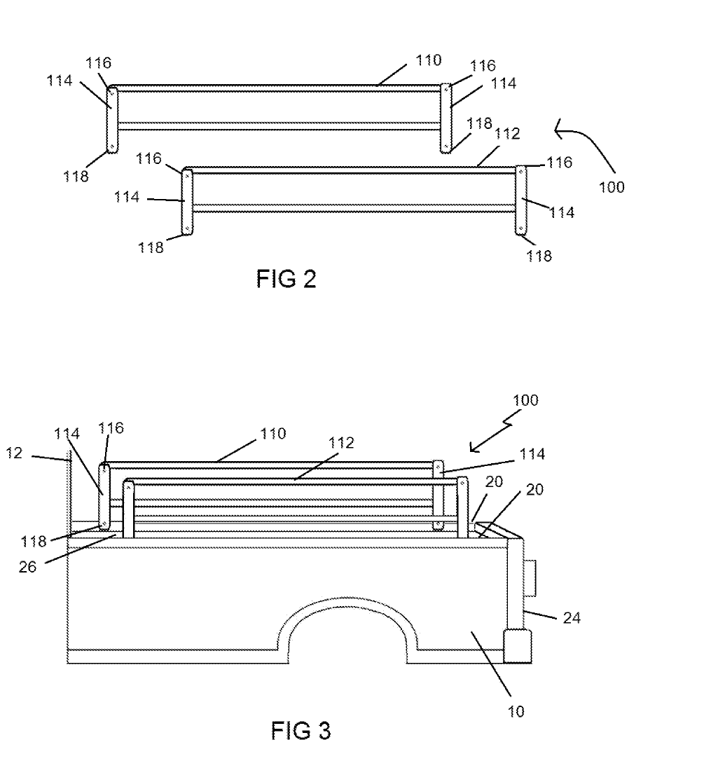

Referring to FIG. 2, there is illustrated a collapsible sidewall height extender generally referenced by numeral 100 for use with a truck 10 as shown in FIG. 1. Referring to FIG. 2, collapsible sidewall height extender 100 includes a first horizontal side member 110 and a second horizontal side member 112. Each of the first horizontal side member 110 and the second horizontal side member 112 have a plurality of support members 114 spaced at intervals. Each support member 114 has a first end 116 and a second end 118.

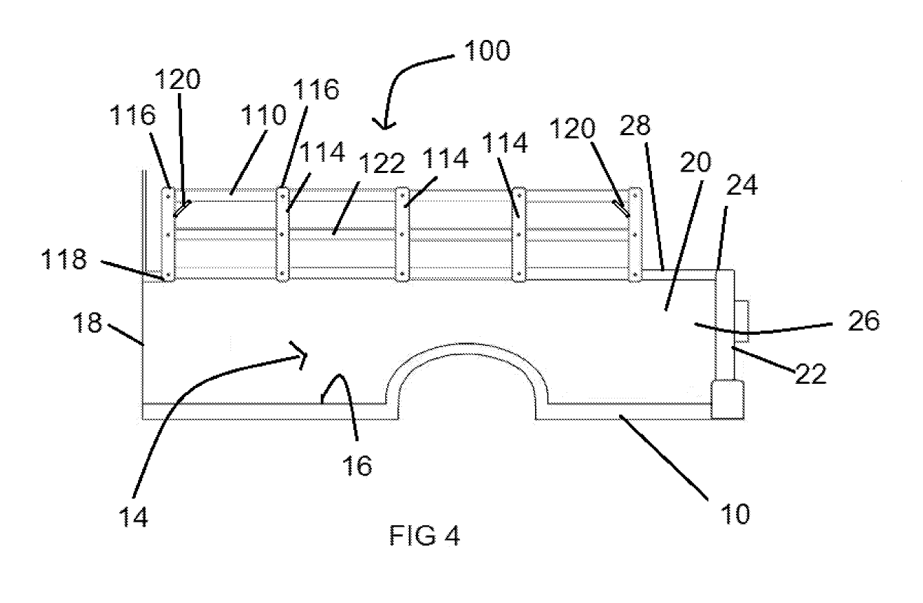

It will be appreciated that each of the first horizontal side member 110 and the second horizontal side member 112 could have as few as one support member 114, or two support members 114 as illustrated in FIG. 3, or several support members 114 as illustrated in FIG. 4 depending on the desired configuration.

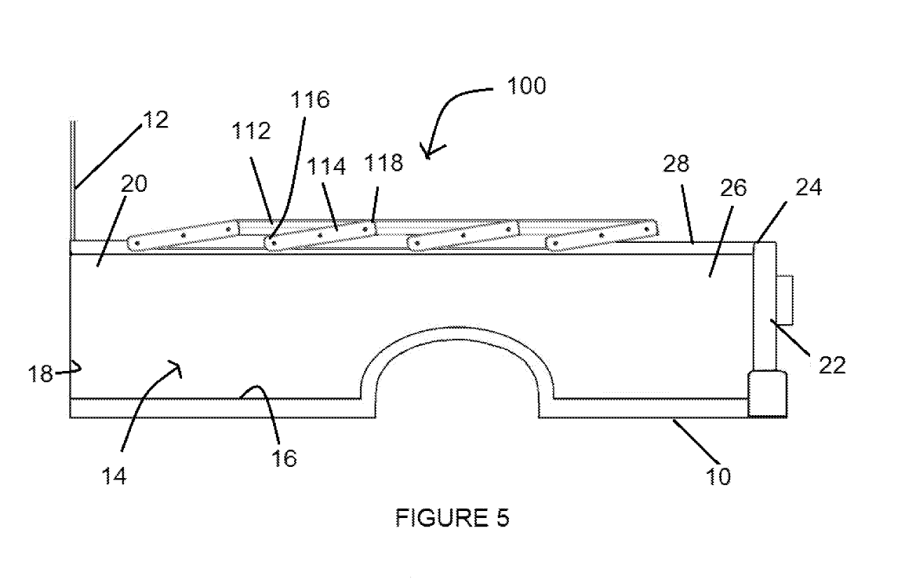

Referring to FIG. 3, the first end 116 of each support member 114 is pivotally secured to the first horizontal side member 110 and the second end 118 of each support member 114 is adapted to be pivotally attached to an inner side 26 of the respective side wall 20 of the storage bed 14 of the truck 10 as illustrated in FIG. 4, such that the first horizontal side member 110 and the second horizontal side member 112 are movable between an operational position illustrated FIG. 4 and a storage position illustrated in FIG. 5. Referring to FIG. 4, the support members 114 are substantially vertical in the operational position with the first horizontal side member 110 and the second horizontal side member 112 being horizontal and spaced from the top edge 28 of the sidewall 20 of the truck 10.

As illustrated in FIG. 4, collapsible leg brackets 120 are positioned toward the first end 116 of two of the support members 114 on each of the first horizontal side member 110 and the second horizontal side member 112, and extends diagonally to the first horizontal side member 110 and the second horizontal side member 112 to maintain and lock the first horizontal side member 110 and the second horizontal side member 112 in the operational position. When the collapsible leg brackets 120 are disengaged, the first horizontal side member 110 and the second horizontal side member 112 can be pivotally moved to the storage position illustrated in FIG. 5 whereby the first horizontal side member 110 and the second horizontal side member 112 are positioned parallel to and proximate to the top edge 28 of the sidewalls 20 of the truck 10.

Referring to FIG. 4, it will be appreciated that there are other types of locking means that can be used to maintain and lock the first horizontal side member 110 and the second horizontal side member 112 in the operational position such as pin coupling (not illustrated) that could be mounted on one or more of the support members 114.

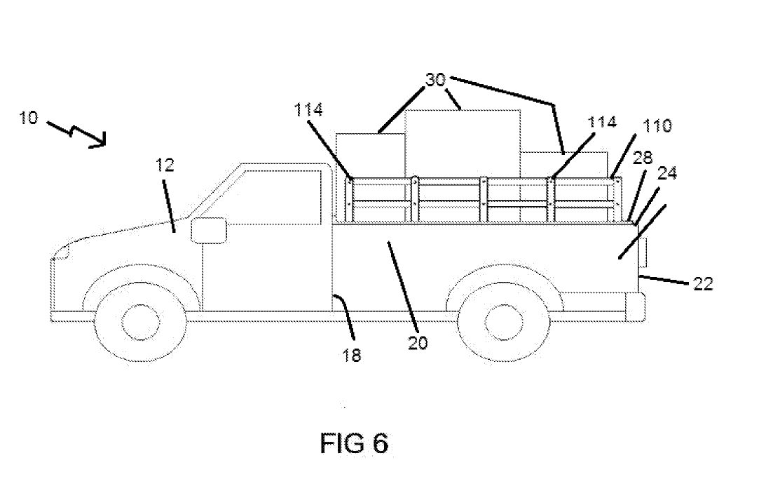

Referring to FIG. 6, the collapsible sidewall height extender 100 can also be provided with additional horizontal stability members 122 to prevent cargo 30 from slipping off or out of truck 10 during use. The horizontal stability members 122 lie parallel to and spaced from the first horizontal side member 110 and the second horizontal side member 112 and as well as being pivotally secured to the support members 114.

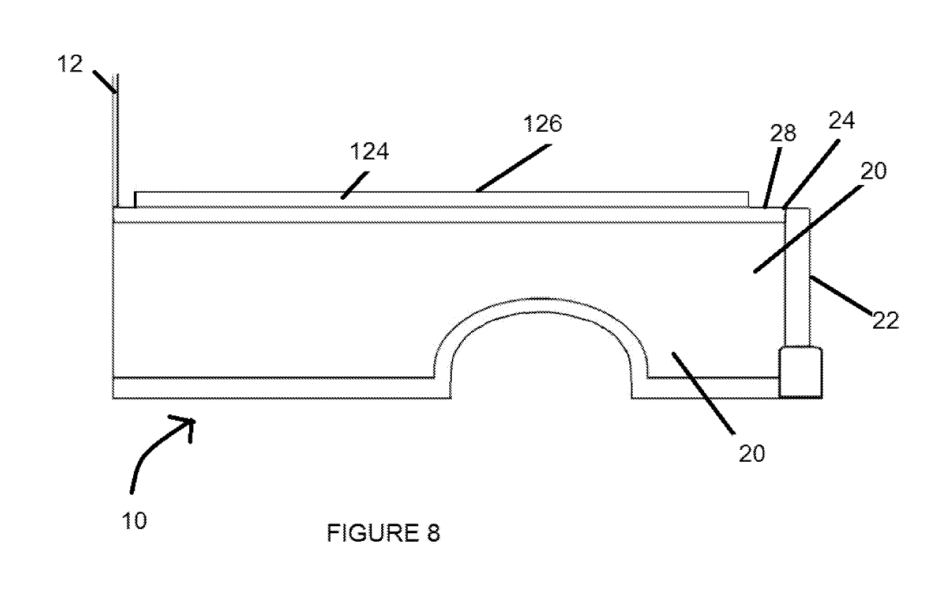

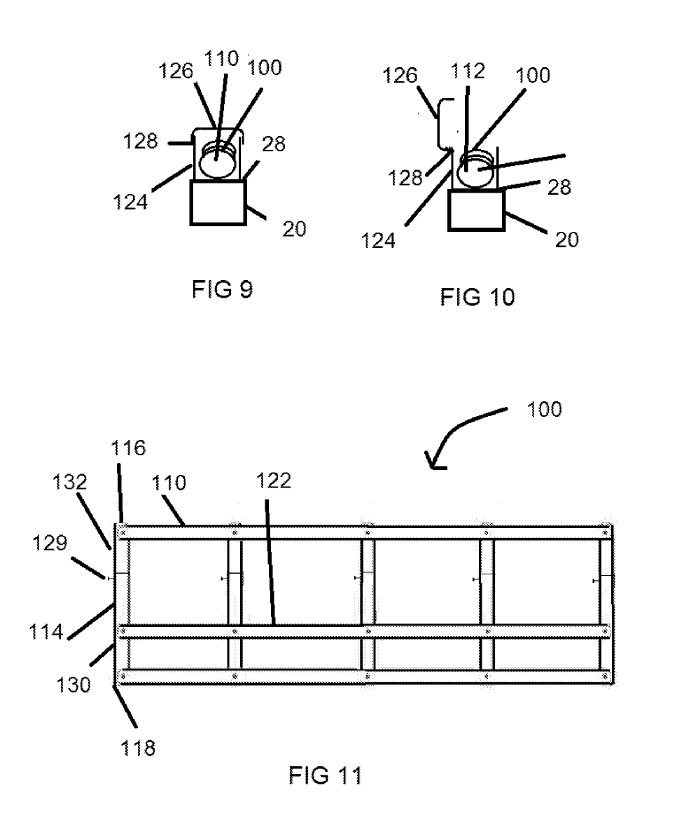

Referring to FIG. 8, FIG. 9 and FIG. 10, each of the first horizontal side member 110 and the second horizontal side member 112 illustrated in FIG. 2 can be provided with a removable elongate storage cap 124 to cover the collapsible sidewall height extender 100 when in the storage position. In the illustrated embodiment, the removable elongate storage cap 124 can be laid over each of the first horizontal side member 110 and the second horizontal side member 112. It can be resting on or permanent attached to the top edge 28 of the sidewall 20 to the truck 10 illustrated in FIG. 1.

Referring to FIG. 8 and FIG. 9, in the illustrated embodiment 100, the storage cap 124 has a lid 126 with a living hinge 128 which can be opened to allow for access to the first horizontal side member 110 and the second horizontal side member 112. The lid 126 can be closed over the first horizontal side member 110 and the second horizontal side member 112 to protect them from the elements or damage when in the storage position.

Referring to FIG. 11, the support members 114 of the collapsible sidewall height extender 100 can also be telescopically adjustable to allow the collapsible sidewall height extender 100 to be extended for greater height. Locking means in form of a pin 129 that is threaded through one telescopic portion 130 to impinge on the other telescopic portion 132 of the support members 144 can be used to lock each support member 114 at the desired telescopic position. It will be appreciated that there are other known means for locking a telescopic support members 114 in position.

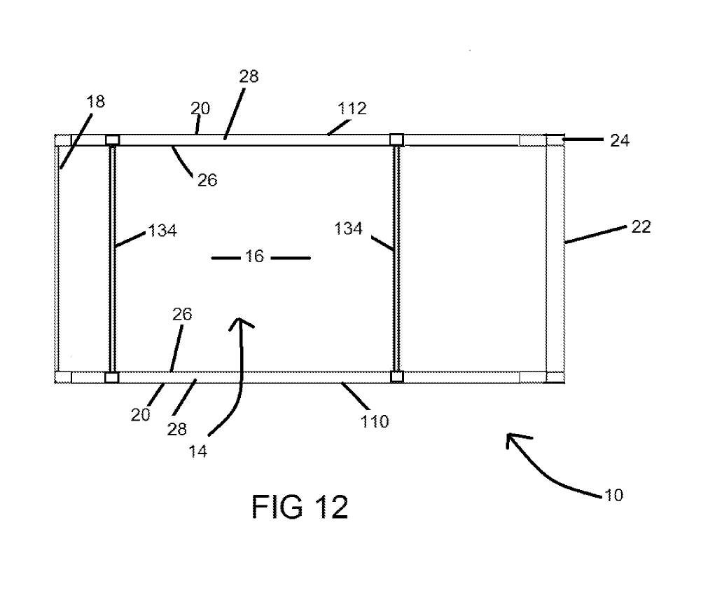

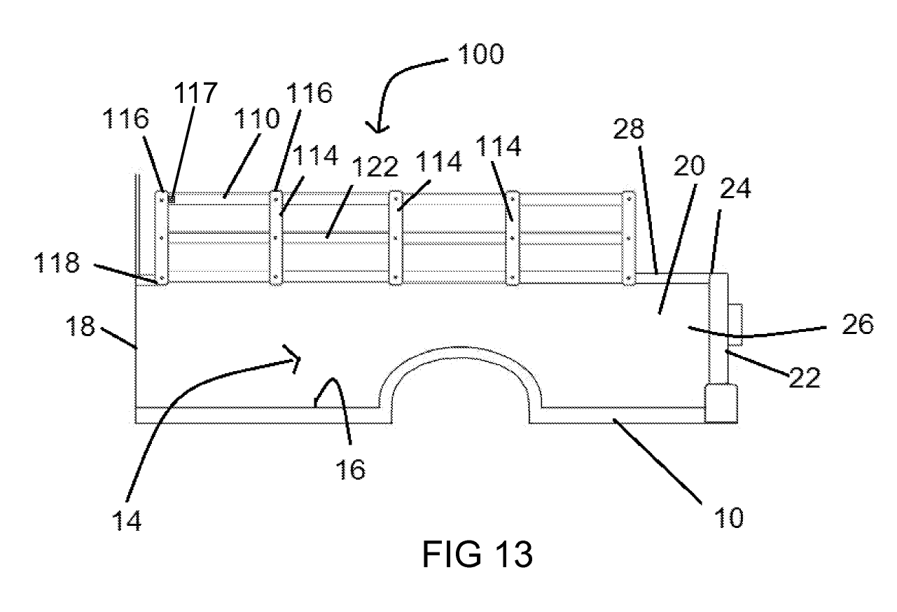

Referring to FIG. 12, the collapsible sidewall height extender 100 can also be provided with transverse stability members 134 which extend between the first horizontal side member 110 and the second horizontal side member 112 to provide more support to first horizontal side member 110 and the second horizontal side member 112 when loads are being carried, particularly where the nature of those loads may cause them to push outward or place outward pressure on the first horizontal side member 110 and the second horizontal side member 112.

Referring to FIG. 3, in the illustrated embodiment 100, the first horizontal side member 110 and the second horizontal side member 112 and the support members 114 are tubular, however they could be planar or a mixture of tubular and planer in configuration. The first horizontal side member 110 and the second horizontal side member 112 could also be oval or various shapes so long as they extend horizontally above the sidewall 20 during use.

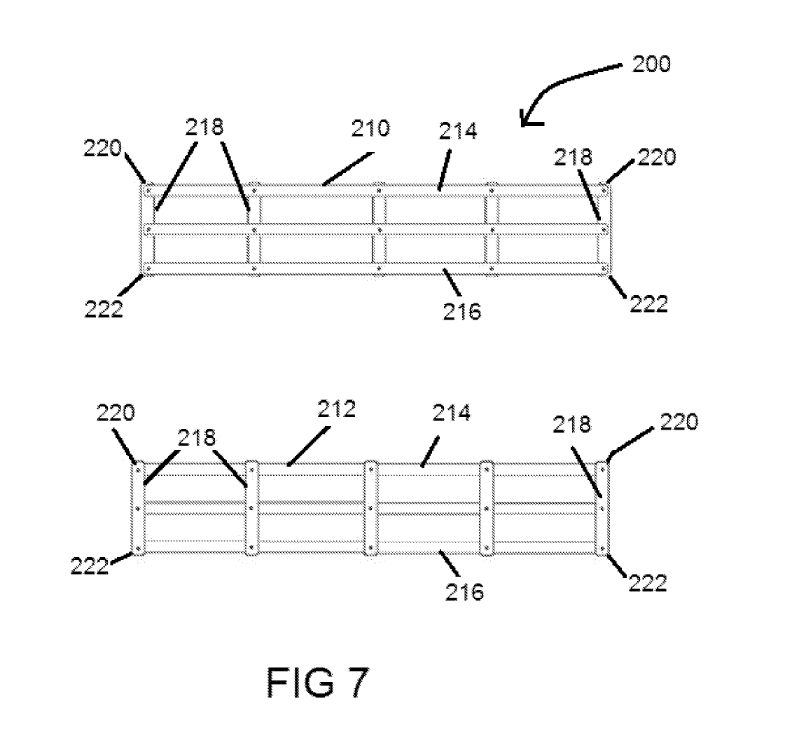

Referring to FIG. 7, there is provided an alternative embodiment of a collapsible sidewall height extender generally referenced by numeral 200 for use with a vehicle having an open storage bed with opposed sidewalls as illustrated in FIG. 1.

Referring to FIG. 7, collapsible sidewall height extender 200 includes a first horizontal side member 210 and the second horizontal side member 212. Each of the first horizontal side member 210 and the second horizontal side member 212 are provided with an upper elongate horizontal rail 214 and a lower elongate horizontal rail 216.

A plurality of support members 218 at spaced intervals are provided which each have a first end 220 and a second end 222. The first end 220 is pivotally secured to the upper elongate horizontal rail 214, and the second end 222 being pivotally secured to the lower elongate horizontal rail 216 such that the upper elongate horizontal rail 214 can move from an operative position illustrated in FIG. 7, spaced from the lower elongate horizontal rail 216, to a storage position like that illustrated in FIG. 5 with respect of the first embodiment 100, where the upper elongate horizontal rail 214 is proximate lying above the lower elongate horizontal rail 216. The lower elongate horizontal member 216 is secured the top edge 28 of each of the respective sidewalls 20 of an open storage bed 14 of a vehicle 10 by bolting or welding or by other suitable means for attaching it to the sidewall 20. The lower elongate horizontal rail 216 provides greater versatility in terms of whether to secure the lower elongate horizontal rail 216 to the top 28 or inner side 26 of the respective sidewalls 20 of the truck 10. As with the first embodiment 100, with second embodiment 200, the support members 218 are in a substantially vertical orientation in the operative position. A pin coupling is mounted on at least one of support members to selectively lock the upper elongate horizontal rail of each of the first horizontal side member 112 and the second horizontal side member 114 in the operative position as illustrated in FIG. 7.

Although not illustrated, the collapsible sidewall height extender 100 can be used in conjunction with side panels, cords or netting to further enhance the ability of the vehicle to contain and carry taller or ballast like materials.

### Operation:

The use and operation of collapsible sidewall height extender for use with a vehicle having an open storage bed with opposed sidewalls will now be described with reference to FIG. 1 through FIG. 12.

Referring to FIG. 1 and FIG. 3, the collapsible sidewall height extender 100 can be installed by mounting the second end 118 of the support members 114 to the inner side 26 of the respective side wall 20 of the storage bed 14 of the truck 10. Accordingly when the user requires extra height in the bed 14 of the truck 10, the first horizontal side member 110 is movable from the storage position illustrated in FIG. 5 to the operational position illustrated FIG. 4. The collapsible leg brackets 120 of first horizontal side member 110 and the second horizontal side member 112 can be engaged to maintain and lock the first horizontal side member 110 and the second horizontal side member 112 in the operational position. As illustrated in FIG. 6, taller cargo 30 can then be transported safely.

When it is no longer necessary to have the height, W the collapsible leg brackets 120 are disengaged, and the first horizontal side member 110 and the second horizontal side member 112 are movable from the operational position illustrated in FIG. 4 to the storage position illustrated FIG. 5. The user can continue to use the truck 10 without removing the collapsible sidewall height extender 100. If desired, the removable elongate storage cap 124 can be laid over each of the first horizontal side member 110 and the second horizontal side member 112 and the lid 126 can be closed over the first horizontal side member 110 and the second horizontal side member 112 to protect them from the elements or damage when in the storage position.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A collapsible sidewall height extender for use with a vehicle having an open storage bed with opposed sidewalls comprising:
a first horizontal side member;
a second horizontal side member;
each of the first horizontal side member and the second horizontal side member having at least one support member having a first end and a second end;
the first end of the at least one support member is pivotally secured to one of the first horizontal side member and the second horizontal side member; and
the second end of the at least one support member is adapted to be pivotally attached to a respective side wall of a storage bed of a vehicle, such that the first horizontal side member and the second horizontal side member are movable between an operational position and a storage position.

2. The collapsible sidewall height extender of claim 1 wherein locking means are provided for locking each of the first horizontal side member and the second horizontal side member in the operational position and the storage position.

3. The collapsible sidewall height extender of claim 2 wherein the locking means is pin coupling mounted on the at least one support member.

4. The collapsible sidewall height extender of claim 2 wherein the locking means are collapsible leg brackets positioned toward the first end of each of two support members, and extending diagonally to each of the first horizontal side member and the second horizontal side member.

5. The collapsible sidewall height extender of claim 1 wherein the at least one support member is substantially vertical in the operational position.

6. The collapsible sidewall height extender of claim 1 wherein the at least one support member includes a plurality of support members at spaced intervals.

7. The collapsible sidewall height extender of claim 1 wherein the at least one support member comprises a first telescopic portion and a second telescopic portion, and is non-incrementally, telescopically adjustable in height.

8. The collapsible sidewall height extender of claim 7 wherein a locking means is provided for locking the at least one support member in a desired telescopic position.

9. The collapsible sidewall height extender of claim 8 wherein the locking means for locking the at least one support member in a desired telescopic position is a threaded pin extending through the first telescopic portion and impinging on the second telescopic portion.

10. The collapsible sidewall height extender of claim 1 wherein each of the first horizontal side member and the second horizontal side member are provided with a removable elongate storage cap to them when in the storage position.

11. The collapsible sidewall height extender of claim 1 further including at least one transverse stability member extending between the first horizontal side member and the second horizontal side member.

12. The collapsible sidewall height extender of claim 1 further including at least one horizontal stability member disposed below each of the first horizontal side member and the second horizontal side member and being pivotally secured to the at least one support.

13. The collapsible sidewall height extender of claim 1 wherein the first horizontal side member and the second horizontal side member are tubular members.

14. A collapsible sidewall height extender for use with a vehicle having an open storage bed with opposed sidewalls comprising:
a first horizontal side member and a second horizontal side member;
each of the first horizontal side member and the second horizontal side member having an upper elongate horizontal rail and a lower elongate horizontal rail;
at least one support member having a first end and a second end, the first end being pivotally secured to the upper elongate horizontal rail, and the second end being pivotally secured to the lower elongate horizontal rail such that the upper elongate horizontal rail can move from an operative position spaced from the lower elongate horizontal rail, to a storage position where the upper elongate horizontal rail is adjacent the lower elongate horizontal rail; and
the lower elongate horizontal rail being adapted to be secured a respective sidewall of an open storage bed of a vehicle.

15. The collapsible sidewall height extender of claim 14 wherein the at least one support member is in a substantially vertical orientation in the operative position.

16. The collapsible sidewall height extender of claim 14 further including at least one transverse stability member extending between the first horizontal side member and the second horizontal side member.

17. The collapsible sidewall height extender of claim 14 further including collapsible leg brackets positioned toward the first end of each of two support members, and extending diagonally to each of the first horizontal side member and the second horizontal side member.
